(19) United States
(12) Patent Application Publication
(10) Pub. No.: US 2022/0138857 A1
(43) Pub. Date: May 5, 2022

(54) SYSTEM AND METHOD FOR NEAR-INSTANTANEOUS PORTFOLIO PROTECTION

(71) Applicant: Adaptive Investment Solutions, LLC, Boston (MA)

(72) Inventors: Dazhen Sun, Lexington, MA (US); Nathaniel Wice, New York, NY (US); Jonathan Wells, Brooklyn, NY (US)

(21) Appl. No.: 17/515,030

(22) Filed: Oct. 29, 2021

Related U.S. Application Data
(60) Provisional application No. 63/107,221, filed on Oct. 29, 2020.

(51) Int. Cl. G06Q 40/06; G06Q 30/02; G06Q 40/04

(52) U.S. Cl. CPC G06Q 40/06; G06Q 40/04; G06Q 30/0201

(57) ABSTRACT

A system and method for near-instantaneous portfolio protection is provided. The portfolio protection tool is configured to be activated/deactivated nearly instantaneously with minimal customer inputs and efficiently provides customizable risk-management solutions for individual investors and advisors alike. The system includes a Market Data Server that receives market data from electronic intra-day financial market data sources, processes and selectively compiles salient market data points. A Risk Pricer Server computes, based on user-defined protection period and protection level settings, a risk level and a price for the protection on the user's portfolio. A Book Manager identifies specific trades required to provide the portfolio protection as a function of an aggregate risk to multiple customers. A Trader is configured to execute the specific trades. The system can throttle asynchronous input data to construct synchronized data sets resolving technical challenges of unsynchronized electronic financial market data.

### CROSS-REFERENCE TO RELATED APPLICATION

The present application claims the benefit of and priority to U.S. Provisional Patent Application No. 63/107,221, titled SYSTEM AND METHOD FOR NEAR INSTANTANEOUS PORTFOLIO PROTECTION, filed on Oct. 29, 2020, the contents of which is hereby incorporated by reference as if set forth in its entirety herein.

### FIELD OF THE DISCLOSURE

The present disclosure relates to electronic systems and methods for trading financial products, and more particularly, to systems and methods for generating portfolio-specific protection that can be activated and deactivated via a simplified user interface and workflow, and that is customizable and can be quoted and generated in an electronic trading system near-instantaneously.

### BACKGROUND OF THE DISCLOSURE

Because hedging financial instruments used for risk management (e.g., “put” options and the like) are usually costly and difficult to obtain, too many investors manage risk by exiting markets, missing out on growth and income. This was manifested dramatically in the Covid Crash of March 2020.

Structured notes, options strategies and other bespoke high-fee risk-management solutions are occasionally sold to high net worth investors. They do not offer “instant quotes”. They are not available to retail investors. Even though they can be “bespoke,” they are not dynamically flexible. They are inefficient, with high sales costs, and high margins and high overhead costs.

While risk-management strategies exist, practical challenges and technical challenges associated with electronic financial trading systems have prevented the advent of electronic tools capable of efficiently and automatically implementing portfolio-specific and customizable risk-management solutions that are useable by individual investors and advisors. As a result, the vast majority of investors today leave their portfolios unprotected, or manage risk by selling and thus missing out on long-term growth opportunities.

It is with respect to these and other considerations that the disclosure made herein is presented.

### SUMMARY OF THE DISCLOSURE

According to an aspect of the disclosure, a system for near-instantaneous portfolio protection is provided. The system comprises an Adaptive Shield Server residing within a private cloud. The Adaptive Shield Server includes a Client and Client Broker API server configured to interface with a Client Broker Server and a Client User Interface. The Client and Client Broker API is configured to retrieve Client Portfolio data from the Client Broker Server for a Customer. Furthermore, the Client and Client Broker API is configured to receive, via the Client Interface, the Customer's actuation of a Shield Button to initiate creation of a portfolio protection product for the Client Portfolio and settings concerning the portfolio protection. The settings include a temporal term that the portfolio protection is active and an amount of coverage, wherein the portfolio protection covers any decline in the Client Portfolio within the amount.

The Adaptive Shield Server further comprises a Market Data Server configured to receive market data including price and order data from one or more Third Party Data Servers. The Market Data Server is configured to coordinate short and long-term storage of such information, and selectively compile market data points.

The Adaptive Shield Server further comprises a Risk Pricer Server configured to compute, based on the settings, Client Portfolio data and the market data points, a risk level and a price associated with the portfolio protection. The Risk Pricer Server is also configured to calculate an aggregate risk of multiple Customers including the Customer. Moreover, the Risk Pricer Server is further configured to construct a plurality of hedges to provide the portfolio protection and as a function of the aggregate risk.

The Adaptive Shield Server further comprises a Book Manager configured to interface with the Market Data Server and the Risk Pricer. The Book Manager is configured to assess and identify specific trades required to provide the portfolio protection as a function of the aggregate risk. The Book Manager is also configured to automatically generate protection purchase instructions for executing the specific trades via an electronic Trader.

The Adaptive Shield Server further comprises the Trader. The Trader is configured to interface with one or more 3rd Party Broker servers and automatically place orders to execute the specific trades in accordance with the protection purchase instructions received from the Book Manager Server.

According to a further aspect of the disclosure, a method for near-instantaneous portfolio protection is provided. The method comprises the step of retrieving, by a Client and Client Broker API Server of a processing system residing within a private cloud, Client Portfolio data concerning a portfolio of financial assets owned by a Customer. In particular, the Client Portfolio data is retrieved from a Client Broker Server.

The method also comprises the step of receiving, by the Client and Client Broker API server from the Client via a user interface presented to a Customer at a remote computing device, an actuation of a Shield Button by the Customer to initiate creation of a portfolio protection product for the Client Portfolio, and receiving settings concerning the portfolio protection, wherein the settings include a temporal term that the portfolio protection is active and an amount of coverage, wherein the portfolio protection covers any decline in the Client Portfolio within the amount;

The method also comprises the step of receiving, by a Market Data Server of the processing system from one or more Third Party Data Servers, market data including price and order data. In particular, the market data comprises real-time and historical data. Furthermore, the method comprises the step of selectively compiling, by the Market Data Server from the received market data, salient market data points and coordinating short and long-term storage of the received market data and the compiled market data points.

The method also comprises the step of computing, by a Risk Pricer Server of the processing system, based on the settings, Client Portfolio data and the market data points, a risk level and a price associated with the portfolio protection. Moreover, the method also comprises the steps of calculating, by the Risk Pricer Server, an aggregate risk of multiple Customers including the Customer and constructing a plurality of hedges to provide the portfolio protection as a function of the calculated aggregate risk.

The method also comprises the step of identifying, by a Book Manager Server of the processing system, specific trades required to provide the portfolio protection as a function of the aggregate risk. In particular, the Book Manager is configured to interface with the Market Data Server and Risk Pricer. Additionally, the method comprises the step of automatically generating, by the Book Manager based on the identified specific trades, protection purchase instructions for executing the specific trades via an electronic Trader.

The method also comprises the step of automatically placing, by the Trader using one or more 3rd Party Broker servers in electronic communication therewith, trading orders to execute the specific trades in accordance with the protection purchase instructions generated by the Book Manager Server.

These and other aspects, features, and advantages can be appreciated from the accompanying description of certain embodiments of the disclosure and the accompanying drawing figures and claims.

### BRIEF DESCRIPTION OF THE DRAWINGS

FIG. 1A is a conceptual block diagram representation of an exemplary configuration of a near-instantaneous portfolio protection (referred to as one-click portfolio protection, OCPP) system according to an embodiment;

FIG. 1B is a detailed conceptual block diagram representation of an exemplary configuration of the OCPP system of FIG. 1A according to an embodiment;

FIG. 2A is a screen shot of a graphical user interface (GUI) interface showing a customer's brokerage account page including a button for activating a “Shield” tool provided by the OCPP system according to an embodiment;

FIG. 2B is a screen shot of a GUI interface showing an exemplary Shield tool parameter setup page according to an embodiment;

FIG. 2C is a flow chart illustrating the interactions and dataflows of the user interfaces of the OCPP system according to an embodiment;

FIG. 3A is a conceptual block diagram representation of an exemplary configuration of the Market Data Server component of the OCPP system according to an embodiment;

FIG. 3B is a conceptual block diagram representation of an exemplary configuration of the Risk Pricer Server of the OCPP system according to an embodiment;

FIG. 3C is a conceptual block diagram representation of an exemplary configuration of the Book Manager Server of the OCPP system according to an embodiment; and

FIG. 4 is a screen shot of an exemplary dynamic and interactive graphical user interface generated by the OCPP system for output to a user in connection with an order for portfolio protection according to an embodiment.

It is noted that the drawings are illustrative and are not necessarily to scale.

### DETAILED DESCRIPTION OF CERTAIN EMBODIMENTS OF THE DISCLOSURE

By way of overview and introduction, systems and methods are disclosed for near-instantaneous portfolio-specific customizable asset portfolio protection—referred to as One-Click Portfolio Protection (OCPP). As should be understood, assets can include stocks, bonds, options among other financial instruments and asset classes.

The One-Click Portfolio Protection System enables Adaptive Shield™ (“Adaptive Shield” or “Shield,” for short; Adaptive Shield™ is a trademark of Adaptive Investment Solutions, LLC of Boston Mass., “Adaptive Investments”). Adaptive Shield is a computer-implemented portfolio risk management tool and solution that can be used by retail investors, financial advisors and institutional investors for the purpose of portfolio downside protection. Although the system is referred to as a One-Click Portfolio Protection system, it should be understood that this is intended to illustrate to the speed and efficiency with which customized portfolio protection can be obtained using the system and is not intended to be limiting. As can be appreciated, the number and form of user-inputs required to configure and activate the protection provided by the OCPP system can vary depending on the application, system configuration and system state.

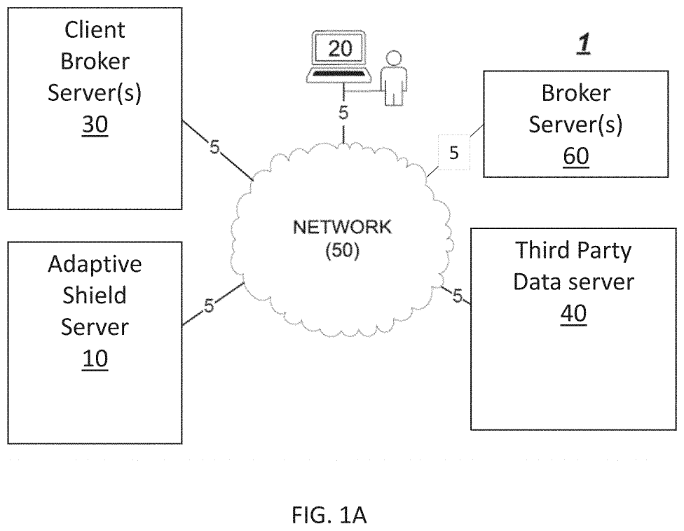

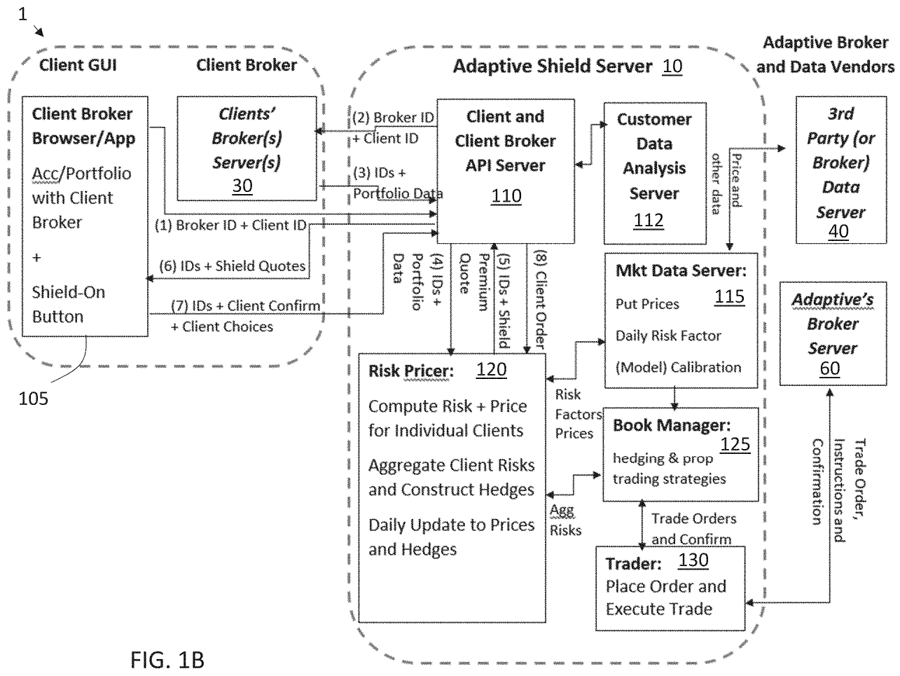

FIG. 1A shows an example configuration of an OCPP system 1, constructed according to the principles of the disclosure. As shown in FIG. 1A the OCPP system 1 can include an Adaptive Shield Server 10 and a computing device 20 operated by a Customer (or “Client” or “user”) of the systems, services and products provided by the Adaptive Shield Server. The OCPP system 1 can also comprise additional computing systems that are in operative communication with the Adaptive Shield Server 10 and that facilitate various features and functionality provided by the Shield Server 10 including the Adaptive Shield tool/product. As shown and further described herein, those computing systems can include one or more third-party client broker servers 30, one or more third-party broker servers 60 (e.g., prime broker servers utilized by the Adaptive Shield Server) and one or more third-party data servers 40. The various components in the OCPP system 1 can be communicatively coupled to each other directly via communication links 5, or via communication links 5 and the network 50.

Adaptive Shield, is a portfolio protection tool configured to be activated and/or deactivated nearly instantaneously with minimal customer inputs/clicks (e.g., with one-click). Simply put, Shield can be activated via an application (“app”) user interface that is presented to the Customer via a Customer's personal computer device(s) (e.g., device 20). In one embodiment, the app can be embedded within electronic investment portfolio management systems that are accessible using a computing device. Similarly, the app can be a standalone application running on a computing device, or a hosted application accessible via an internet-based portal.

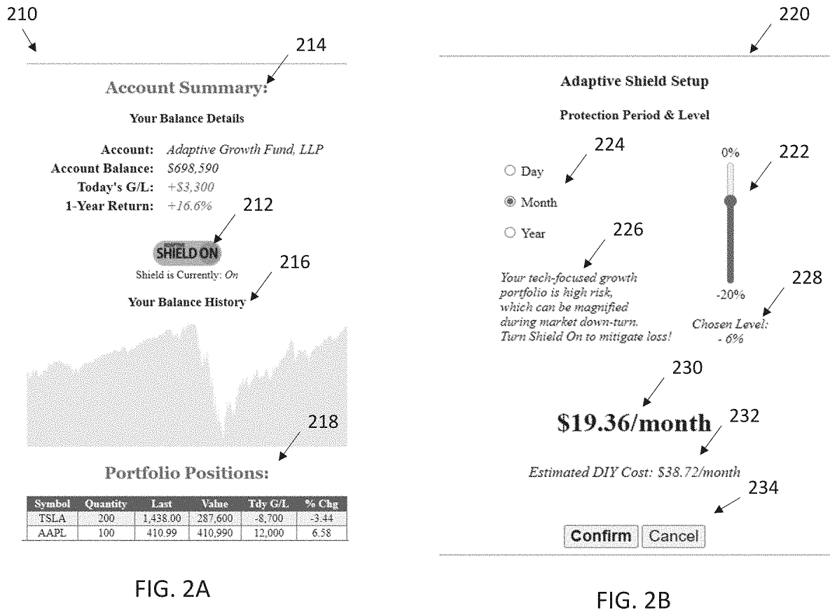

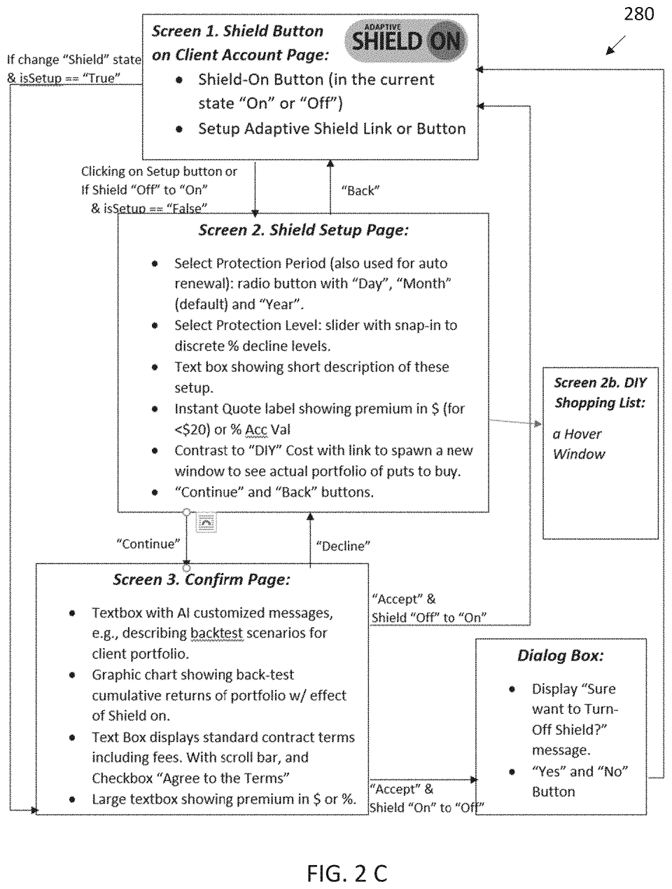

In response to such activation, the OCPP system 1, more particularly, the Shield Server 10, is configured to near-instantaneously provide customers with portfolio protection that is specifically tailored to customers' unique portfolios. For example, in an embodiment, a Shield Customer (see below) can click on a Shield button embedded on her electronic on-line mutual fund and brokerage account pages serviced by her broker (or an aggregate account page serviced by provider such as Adaptive Investments) to activate portfolio protection with pre-configured parameters (such as protection level, and protection period as further described herein). FIG. 2A illustrates a screen shot of an exemplary version of the interface.

Via the graphical user interface the OCPP system 1 is configured to provide Customer the following functionalities/features: an instantaneous real-time price quote for protecting a specific portfolio (“Client Portfolio”) according to the Customer-defined settings, Customer-defined protection term by, for example, and without limitation, the Day, Week, Month, Quarter, or Year, and customer-defined coverage for declines of any percentage (e.g., 3%, 5%, 10%, 20%). Put another way, Shield is a mass-customizable risk management tool for self-directed investors that is configured to provide protection for a portfolio of stocks and bonds that will cover all losses beyond a customer-defined threshold (e.g 10%) at any set time expiration (e.g., not just a third Friday of the month) and that is configured to be turned on and off with the customer's click of a button within the user interface. Additionally, the OCPP systems are further configured to provide instant real-time quotes and live quote updates.

The features and services offered to the Customer via the Shield interface, from customer interface, generating quotes, to executing hedging trades, is implemented in an automated fashion by the OCPP system 1. The OCPP system is architected to specifically handle the technical challenges required for this.

The end user of the OCPP systems and methods is referred to as a Shield Customer (or simply “Customer” or “Client”) and is someone who holds a portfolio of publicly traded financial assets, which can include: common stocks, bonds, mutual funds (MF), electronically traded funds (ETF), futures, and other exchange listed derivatives and the like (“Client Portfolio”). This Customer can activate Shield in order to protect the principal value of the Client Portfolio. Adaptive Shield, the associated OCPP system and related services are offered and serviced by a provider (“Adaptive” or “Provider”).

In an embodiment, the OCPP systems and methods are configured such that the Shield Customer can access Adaptive Shield™ directly by clicking on the “Shield-On” button embedded on the Customer's individual brokerage account page or an aggregate account page. If the Customer has preconfigured protection settings, the Shield Server 10, can be configured to present the Customer with a live quote (which can continuously be updated in real-time as market prices change), and enable the Customer to simply confirm that the Shield is be activated. If the Customer has not pre-configured protection parameters, or would like to change these parameters, she can be presented with a setup page. The setup page of the user interface is configured to enable the Customer to select protection periods and protection level. As she inputs these choices, the Shield Server 10, is configured to calculate a quote that is rendered immediately on the page and is updated immediately as she adjusts Shield Parameters. She can then confirm or cancel her Shield order. Once Shield is activated, Adaptive and its business partners can handle the collection of premium payment and provide any payout to Customer at the end of protection period, directly settled in her brokerage account.

FIG. 2A is a screen shot of a GUI interface 210 showing an exemplary Customer's brokerage account page, and the “Shield-On” button 212 associated with the Shield tool according to an embodiment. FIG. 2B is a screen shot of a GUI interface 215 showing an exemplary Shield Parameter setup page according to an embodiment. FIG. 2C is a flow chart illustrating the interactions and dataflows of these and other user interfaces according to an embodiment.

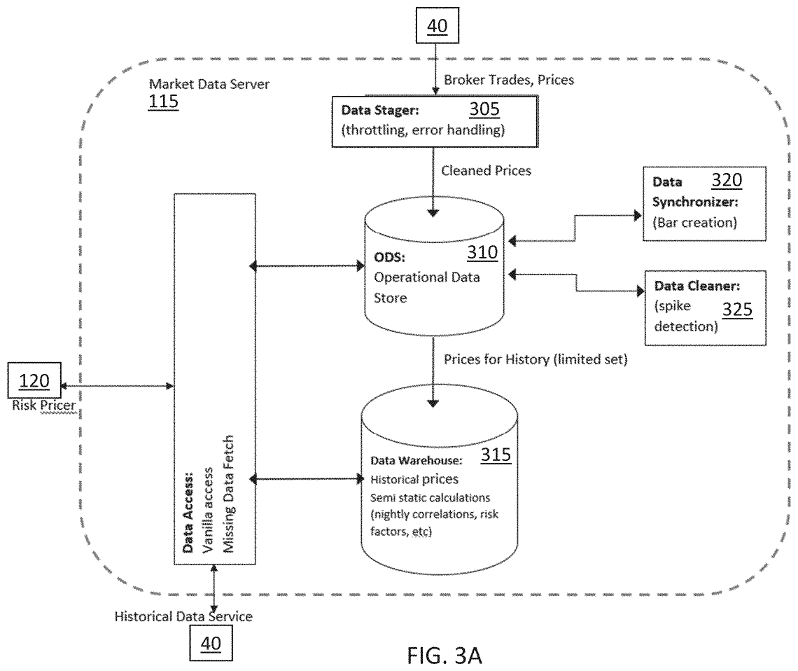

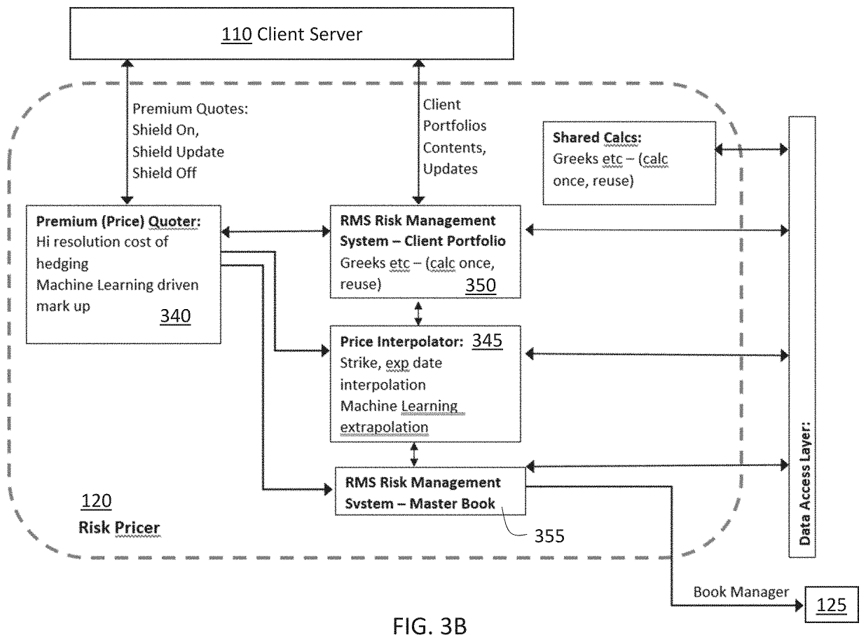

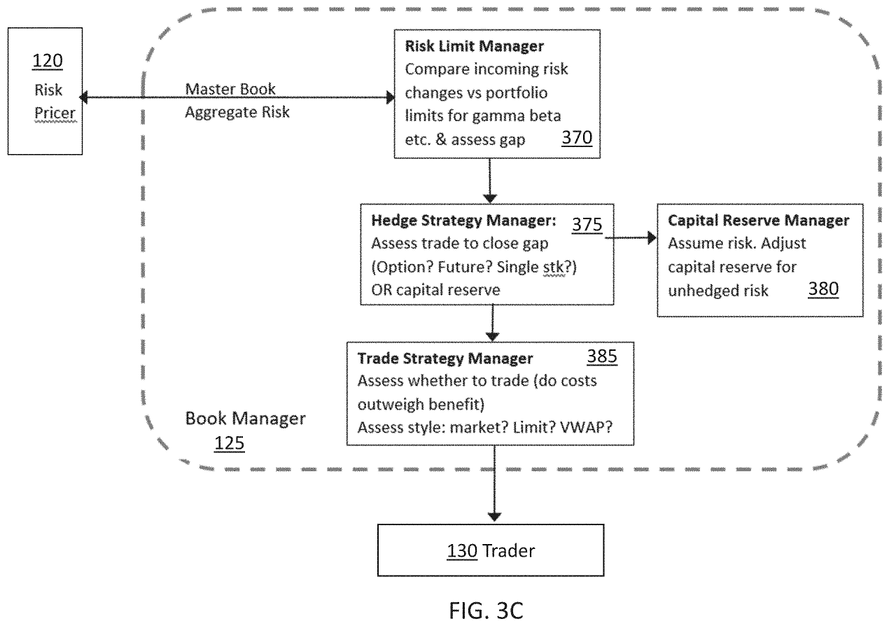

The OCPP systems and methods that enable the features, functionality and services for Adaptive Shield to the Customer are shown and described in connection with FIGS. 1B, 3A-3C and with continued reference to FIG. 1A. FIG. 1B is a block diagram providing a more detailed representation of an exemplary configuration of the OCPP system 1 according to an embodiment. In an embodiment, the OCPP system 1 can include the components briefly defined next.

As noted, the OCPP system 1 can include an Adaptive Shield Server 10. Generally, the Adaptive Shield Server is a collection of database servers and application servers residing within a private cloud. The Adaptive Shield Server interacts with user-facing systems including a Client GUI and Client Broker Servers (e.g., Client Broker Server 30). The Adaptive Shield Server also interacts with further back-end servers and systems of 3^{rd} party systems and services such as prime brokers (e.g., broker server 60) and/or third-party data providers (e.g., 3rd party data server 40) that interface with the Adaptive Shield Server to facilitate operation of the OCPP systems and methods.

Client facing elements of the OCPP system 1 can include an Adaptive Web Browser or App 105. In some embodiments, the Adaptive Web Browser or App 105 can comprise a stand-alone application (app), web-browser portal or software application configured to act as an aggregator of a Customer's multiple brokerage accounts. Accordingly, the Adaptive Web Browser or App can be configured to maintain a “Meta-Account” that can serve as a user interface within which the “Shield” button can be embedded. In addition or alternatively, features and functionality of the adaptive

Client-side elements of the OCPP system 1 can also include a Client GUI (Graphic User Interface). Client GUI refers to a graphical user interface as described above. For example, the Client GUI can comprise the Customer's account or portfolio position page with a 3rd party broker (e.g., Client's Broker Server). In such a configuration, the Adaptive Shield button can be embedded directly on the Customer's account page or portfolio position page, which is accessible through the 3^{rd}-party web-portal or dedicated application.

Client Broker Server 30 represents a Customer's 3rd party broker server, with which the Adaptive Shield Server 10, and more particularly the Client and Client Broker API server 110 further described herein, can interface with in order to: communicate Customer account data to and from the 3rd party broker system; initiate transactions on behalf of Customer (e.g., if the 3rd party broker acts as underwriter of Shield protection); and collect fees from Customer account or from Client Broker.

As shown in FIG. 1B, in some embodiments, the Adaptive Shield Server 10 can comprise the following sub-components: Client and Client Broker API (Application Programing Interface) Server 110; Customer Database and Analysis Server 112; Risk Pricer Server 120; Market Data Server 115; Book Manager 125; and Trader 130. Although these and other elements of the OCPP system 1 are referred to as a “server,” these components are not intended to be so limited as they can be realized using computers, or hardware and/or software-based computing modules.

FIG. 3A is a conceptual block diagram representation of an exemplary configuration of the Market Data Server 115 component of the Adaptive Shield Server 10, according to an embodiment. FIG. 3B is a conceptual block diagram representation of an exemplary configuration of the Risk Pricer Server 120 of the Adaptive Shield Server 10, according to an embodiment. FIG. 3C is a conceptual block diagram representation of an exemplary configuration of the Book Manager Server 125 of the Adaptive Shield Server, according to an embodiment.

Continuing on, in reference to FIG. 1B, the Client and Client Broker API 110 is configured to interface with one or more of the Client Broker Server 30, Client Broker Browser/App and Adaptive Web Browser/App 105. In this regard, the Client and Client Broker API can retrieve Customer information and Customer Portfolio data. Client and Client Broker API is further configured to receive inputs and settings from the Customer, such as a Customer switching/clicking the Adaptive Shield Button and any related Shield parameters/settings via the Client GUI. Such Customer information, portfolio data and Shield-specific commands and settings are further provided by the Client and Client Broker API to elements of the Adaptive Shield Server 10 including the Risk Pricer 120 and Customer Data Analysis Server 112 to facilitate various aspects of the OCPP systems and methods disclosed herein.

In an embodiment, the Customer Data and Analysis Server 112 comprises a datastore (e.g., database) for storing customer data for use by the rest of the Shield Server 10, such as, details about the Customer, her credentials, her portfolio(s), and activity history. The analysis component of the Customer Data Analysis Server 112 can comprise a customer relationship management (CRM) and data analysis component. For example, as further described herein, the server 112 can analyze the stored customer data to determine which customers are likely to buy Shield. The customer details stored in the customer database can be used by the analysis server and/or other parts of the Shield Server 10 in order to, for instance, predict how likely a Customer is to buy the Shield product, and potentially make preemptive trades if determined that the Customer is very likely to order the Shield.

Based on a Customer's actuation of the Shield button, Shield settings and portfolio data received via the Client and Client Broker API server 110, the Risk Pricer Server 120 is configured to compute the risk and price associated with an individual Customer's order or prospective order for the Shield. The Risk Pricer Server is also configured to calculate an aggregate of multiple Customers' risks and construct hedges accordingly.

The Market Data Server 115 receives price and order data from one or more of the Third Party (or Broker) Data Servers 40, manages short and long-term storage of such information, calculates various salient market data points including put prices, daily risk factors and the like. The Market Data Server further builds and maintains models for predicting various data points that are input to the Risk Pricer Server 120 including risk factors and pricing information.

The Book Manager 125 is also configured to interface with the Market Data Server 115 and Risk Pricer 120. The Book Manager 125 is configured to assess specific trades required to manage the aggregate risk, and then purchase protection accordingly via the Trader. The Trader 130 is configured to interface with the 3^{rd} Party Broker server(s) 60 and automatically places orders and executes and confirms trades in accordance with the instructions received from the Book Manager Server.

In order to provide Shield Customer the Adaptive Shield tool providing the one-click portfolio protection system and underlying services, the OCPP system 1 is specifically configured to overcome various technological challenges and deficiencies of electronic trading systems and related systems in the financial technology field.

According to a salient aspect, the OCPP system, particularly the Adaptive Shield Server 10, is specifically configured to resolve technical challenges of electronic intra-day financial market data not being synchronized. By way of background, intraday financial market data including, for example, stock prices and stock and option prices are not synchronized. There are two drivers for this asynchronization, 1) financial market structure and 2) system delays. With respect to the first driver, trading in financial markets is not synchronized, meaning that different stocks and options do not trade at the same time. For the most part, liquid stocks trade throughout the day. The quotes (bid/ask) are normally available and these prices are likely to be current and can generally be relied upon to reflect current “true” prices. However current true prices for stock options, even for liquid stocks, are not always available at every strike price and every expiration set up by an exchange (e.g., the options exchange, for example, the Chicago Board of Options, publish and maintain standard options for trading at various preset strikes and expirations). In many cases certain combinations of strike and expiration dates can have very thin or no open interest at all. This asynchronous data creates a challenge in calculating instantaneous true prices of multiple different stock options, for example, as would be required in order for the OCPP system's price engine to price the Shield costs for one or more Shield Customers and update costs in real time.

A second driver for asynchronous financial market data are system delays in the electronic trading and reporting systems. More specifically, system delays can cause the unsynchronized arrival of market data prices such that, even if certain trades have already occurred at the exchange, an electronic data vendor might not have received the most recent quotes and prices, or the most recent quotes and prices are not available to the OCPP system.

According to a salient aspect, the OCPP system can be specifically configured to resolve the technical challenge of asynchronous market data. In particular, in an embodiment, the Market Data Server 115 (FIGS. 1B and 3A) can comprise a Data Stager 305 (FIG. 3A) module. The Data Stager receives market data (e.g., broker trades and price data) from 3^{rd} Party Data Server 40. The Data Stager module is configured to throttle the arrival of intra-day real-time market data such that, instead of relying on an asynchronized panel of data, the Data Stager creates and then provides a most recent “full” time-bar (a bar of data is a slice of data in time, which are assumed to have occurred in the same time interval) to an Operational Data Store 310. The Operational Data Store 310 maintains a set of “Live Prices,” current/recent market data, for use by various modules of the Adaptive Shield Server. Market data points from the Data Stager can also be provided to a historical Data Warehouse 315 (FIG. 3A) for storage and retrieval. Furthermore, in some embodiments, the Data Stager 305 can be configured to stage more recent but incomplete bars of data for application of one or more of a plurality of real-time data analysis operations such as error handling, price interpolation and prediction using one or more known or proprietary statistical and machine learning algorithms. As shown in FIG. 3A, in some embodiments, one or more of the exemplary steps for bar creation and data synchronization can be performed by a Data Synchronization module 320 in operative communication with the Operational Data Store 310. In some embodiments, the Data Stager can be omitted and the risks associated with asynchronous market data can be compensated for in other ways by the Adaptive Shield Server 10.

Additionally, the Risk Pricer 120 (FIG. 1B and FIG. 3B) can be configured to retrieve previous full-time bars from the Operational Data Store 310 and to interpolate missing data in individual time bars. For example, the Risk Pricer 120 can be configured to implement one or more known or proprietary interpolation algorithms comprising a combination of time-series statistical estimation techniques (for example, Maximum Likelihood time-series analysis) and machine learning algorithms to discover, analyze and calibrate structural relationships as well as statistical correlations between prices of stocks and options, and among different strikes and expirations of the option contracts on the same stocks.

Furthermore, the Risk Pricer 120 can also be configured to implement a deep-learning algorithm trained on historical data representing the relationship between previous time bars at varying intervals and current time-bar to project (predict) prices of a newest incomplete time-bar. The Risk Pricer can be further configured to further adjust those predicted prices as more data comes in for the newest time-bar. It should be understood that, for the purpose of this exemplary configuration of the OCPP system 1, a full-time bar is not necessarily a complete time-bar (a time-bar that contains price data for all financial instruments under consideration). The “fullness” of a time bar that is suitable for performing the pricing operations disclosed herein can be learned and defined by one or more modules of the Shield Server 10 (e.g., the Risk Pricer 120) automatically from historical price data which contracts are likely to have price data within certain time intervals during a trading day.

In some embodiments, the Market Data Server 115 can further be configured to address the problem of synchronization of data arriving at different frequencies by implementing specific database schemas for storing and processing respective data categories for more optimal retrieval or further processing if necessary. For instance, the Market Data server 115 can be configured to implement specific database schemas that separate historical data from real-time data, and separate “simple”-structured data from “complex”-structured data to un-structured data. More specifically, historical data, such as the close of stock price data, daily volume and the like, which typically is updated with relatively lower frequency, can be maintained in a first database. Real-time data, which can be lower quality data having errors, is preferably handled with greater diligence. For example, data “spikes” can occur, in which prices can suddenly jump. Such prices can be completely erroneous, or they can be real yet anomalous, such as during the Flash Crash of 2010 in which some trades were struck at $0.01 and were subsequently reversed. In either case the Market Data Server 115 can comprise a data cleaner 325 (FIG. 3A) for detecting such errors or anomalies and excluding them from model pricing inputs. Accordingly, the Market Data Server, particularly the Data Stager 305 and the ODS 310, can be configured to maintain a separate database in the ODS for real-time data. Additionally, the Market Data Server can separate real-time data based on type, category, characteristic, etc., allowing for the selective application of tailored data analysis and processing algorithms based on the particular type of real-time data. Additionally, the Market Data Server can be configured to reserve reconciliation of the real-time data until the time of use in order to reduce computational load that would otherwise be needed to recalculate every algorithm for every single incoming price.

According to a salient aspect, the OCPP system 1, particularly the Adaptive Shield Server 10, can be specifically configured to resolve the technical challenges concerning synchronization of confirmation of an individual Customer order and execution of hedging trades for the aggregate book. By way of background, the OCPP system can be configured to provide Shield Customers a quote for a period of time—seconds or minutes, that is a market-efficient, “fair” quote for portfolio protection (e.g., at a fair cost to the Customer and the Provider). However, meanwhile the market is constantly moving, potentially against Provider. In principle, Provider cannot place hedging trades when a Customer's quote request is received, otherwise Provider might face reversal costs if the quote is not accepted by the Customer. However, if Provider waits for Customer(s) to confirm an order with a stale (e.g., outdated) price quote to execute hedging trades, the cost of hedging trades might no longer correspond to the Shield prices quoted to Customers, potentially exposing Provider to financial risks.

According to an embodiment, the following elements and operations of the Adaptive Shield Server 10, including the Risk Pricer Server 120 (shown in detail in FIG. 3B), serve to resolve the technical challenge of asynchronous timing of Customer orders and execution of hedging trades.

More specifically, in an embodiment, the Risk Pricer 120 (FIG. 1B and FIG. 3B) can include a Premium Quoter 340 that can be configured to interact with a Price Interpolator 345 and apply one or more known or proprietary statistical and machine learning algorithms to assess a statistical distribution (ranges) of likely future risk and prices. For example, the algorithm can estimate that a Shield price quoted to a Customer at time, t, Pₜ, might evolve to P_{t+Δt}, at the time the Customer confirms the order, and Adaptive executes the hedge, t+Δt. Consider,

ΔP_{t+Δt}=P_{t+Δt}−Pₜ∈θ(ΔP_{t+Δt},t+Δt|t)

where, θ(ΔP_{t+Δt}, t+Δt|t) is a probability distribution of the Δt time-step forward change in Pₜ, conditioned on all prior knowledge up to time t. Given this distribution, there exists a statistically optimal price P*_{t+Δt}, which minimizes the ΔP_{t+Δt} and the financial risk to Provider simultaneously. Accordingly, the Adaptive Shield Server can then quote (and honor) P*_{t+Δt} to the Customer.

In addition, in some embodiments, the Premium Quoter 340 can be configured to apply machine learning algorithms to predict Δt, the time it takes for the Customer to consider the quote before confirm or cancel, and the likelihood that the Customer will confirm the order. This prediction can be based on the Client Portfolio, her individual profile, and market conditions. More specifically, in an embodiment, the Adaptive Shield Server 10, including for example the Customer Data Analysis Server 112 and/or Risk Pricer 120, can be configured to analyze of the Customer's profile (e.g., past activity, historical of use of Shield, trading activity, demographics, and other such customer data) using suitable behavioral analysis algorithms.

In some embodiments, if the Premium Quoter 340 determines that the Customer is likely to place the order, it can be configured to issue the order to the Book Manager 125 (FIGS. 1B and 3C) to add the Customer risk exposure to the aggregate book. This will trigger the Book Manager 125 to perform a reevaluation of the risk of the aggregate book (i.e., the combined risk exposure from all Adaptive Shield Customers), and determine whether and what additional hedges are required, which will then determine the actual incremental hedging trades to be passed to the Trader server 130. In some embodiments, the system can be configured such that the foregoing occurs even in advance of the Customer actually placing the order, thereby allowing the Adaptive Shield Server 10 to more quickly execute on the order when it is placed.

According to a salient aspect, the OCPP system 1, particularly the Adaptive Shield Server 10, can be specifically configured to resolve technical challenges associated with retail Customers' protection needs being typically continuously variable, whereas liquid hedging instruments have discrete contract values. For example, a Customer might want to use the Shield tool to protect for a decline in value of no more than 4% for 36 days until an election is over, however, liquid instruments for hedging expire end of month or week for discrete strike prices that do not exactly provide a 4% level of protection. As would be understood, option parameters are standardized by option exchanges, for instance, stock options trade on the Chicago Board of Option Exchange, and have standard discrete strike levels, and expiration dates.

According to an embodiment, the following elements and operations of the Adaptive Shield Server 10, including the Risk Pricer 120 (shown in FIG. 3B), serve to resolve the technical challenge of asynchronous timing of Customer orders and execution of hedging trades.

More specifically, the Price Interpolator 345 (FIG. 3B) can be configured to convert the protection level and protection period selected by the Customer to theoretical strikes and expiry of the hedging instruments that the Book Manager 125 (FIG. 3C) can use to hedge the incremental risk to the aggregate book. The Price Interpolator can then compute a theoretical price based on the theoretical strikes and expiries using option pricing models that are calibrated using the prices of tradeable options for the same underlying period.

The Price Interpolator 345 can also be configured to apply one or more known or proprietary statistical and machine learning algorithms that capture the dependencies and correlations among options with different underlying stocks to select the best “cross-hedging” (i.e., hedging with alternative instruments) strategy and price them accordingly. The Price Interpolator 345 is further configured to then determine the optimal combination of theoretical and hypothetical hedging costs and the tradeable hedging costs as bases for generating the price quote.

In some embodiments, the Adaptive Shield Server 10, particularly the Risk Pricer 120 (FIG. 3B) and Book Manager 125 (FIG. 3C) can be configured to selectively leave certain incremental risks temporarily unhedged, and accordingly reserve a suitable amount of capital (e.g., in the Providers statutory capital account) for potential losses. The incremental capital reserve can be determined by the Book Manager 125 based on the price of the theoretical hedges. It is assumed that the Book Manager is configured to execute hedges that are tradeable, albeit the actual hedging trades for the aggregate book may differ from the sum of those hedges estimated for individual Customers. The Risk Pricer 120 is thus configured to communicate with the Book Manager 125 to determine the likelihood of Book Manager to actually hedge certain risk or leave it unhedged, and accordingly underwrite such “unhedged” risks directly by reserving appropriate amount of capital in the Provider's statutory capital account.

According to a salient aspect, the OCPP system 1 can be specifically configured to, in near-real time, offer Customers protection premiums which are cost-effective enough to encourage Customers to insure their portfolios, as opposed to remaining uninsured. Put another way, the OCPP system is configured to generate a real-time quote which is also a market-efficient, “fair” quote for portfolio protection sought by the customer.

The majority of retail investors, and indeed investor advisors, do not currently purchase portfolio protection. Although this leaves them fully exposed to large moves in the market, they are not currently acclimatized to giving up some amount of investment gain in return for downside protection. Furthermore, protection is particularly effective if it protects the Customer's individual portfolio not that of some theoretical market indexes (e.g., S&P500). Do-It-Yourself (DIY) hedging using listed individual stock options is expensive, complex, and inexact. Adaptive Shield provides a tool to effectively protect Customers' portfolios at a pricing level low enough for customers to view protection as worthwhile.

The OCPP system 1, particularly the Adaptive Shield Server 10, is configured to implement a strategy for providing, in near real time, cost-effective protection to Customer's individual portfolio that is based on the principles of 1) diversification when aggregating financial risks from individual portfolios, and 2) the economy of scale which allows the OCPP system to automatically hedge aggregate risks with liquid instruments that generally have high notional amount greater than individual investors account sizes.

For an example of economy of scale (1), a single individual stock option has a notional amount that is equivalent to 100 shares of the stock. Amazon stock trades near $3,000 per share. This translates to a notional amount of $300,000 for a single option on Amazon. An individual Customer who owns $100,000 worth of Amazon stocks (˜33 shares), therefore has a choice to either greatly over-hedge her exposure to Amazon, or remain completely unhedged—neither is desirable or cost effective. Meanwhile, the OCPP system is configured to aggregate the Amazon exposure from all its Customers to provide a more precise hedge.

For an example of the diversification benefit, when aggregating risk exposure from the OCPP system Customers, the combined exposure may quite closely resemble a stock market index, such as S&P500, Nasdaq Composite, etc. Therefore, rather than hedging the aggregate exposure using individual stock options, the OCPP system can be configured to hedge the majority of the risk by using options on relevant stock indexes, which are more liquid and therefore more cost effective. In addition, the portions of individual stock risks that are not correlated with market indexes (which, in finance are called “idiosyncratic risks”) will generally diminish as individual stocks are combined across the aggregate book.

The diversification benefit thus described are similar to risk pooling of financial products like auto, home, life and other property and casualty insurance. The critical difference is that in the financial markets, risk characteristics are (more) dynamic than in the physical world, both in speed, magnitude and complexity. Additionally, financial risks are heavily and rapidly influenced by changing behaviors and preferences of market participants. Facilitating this risk aggregation, as well as accounting for the dynamics of financial risk, is a technical challenge which prevents retail investors from being able to achieve a cost-effective protection for their portfolio. According to an embodiment, the following elements and operations of the Adaptive Shield Server, including the Risk Pricer 120 (shown in FIG. 3B), serve to resolve the foregoing technical challenge(s).

In particular, as shown in FIG. 3B, the Risk Pricer 120 can comprise a Client Portfolio Risk Management System (RMS) 350 that can be configured to assess risk for the individual Client Portfolio being quoted. The Risk Pricer 120 can further comprise a Master Book RMS 355 that can be configured to aggregate risk across all Client Portfolios, and can assess the aggregate risk that needs to be protected, after accounting for savings from inter-portfolio correlation/diversification across all insured portfolios. The interaction between the Client RMS 350 and Master RMS 355, which is facilitated by Price Interpolator 345 (see above for more on Price Interpolator), also serves to determine the incremental risk exposure to Provider's aggregate book (Master Book) from an individual Client Portfolio, for the purpose of assessing costs of the Shield tool for that Customer. The Book Manager 125 (FIG. 3C) is configured to assess specific trades required to manage this aggregate risk, and then purchase protection at wholesale prices.

The Premium Quoter 340 is configured to interact with the Client Portfolio RMS 350 and the Master Book RMS 355 to formulate a hypothetical incremental hedging strategy and compute a price. This hypothetical hedging strategy which is informed by a trading algorithm implemented in the Book Manager 125 is not necessarily identical to the trades issued by the Book Manager at all times. This is because, in the aggregate, the Book Manager is configured to evaluate hedging strategies from multiple Customers who might submit Shield orders during the same time, and that aggregate hedging trade might not correspond to the incremental hedging of individual Customers' risk exactly. In order to minimize potential discrepancy between the Shield price quoted to the Customer and the actual costs incurred for hedging the aggregate book, in some embodiments, the Price Interpolator 345 can be configured to utilize a deep-learning algorithm that combines the changing behavior of Customers and the conditions of the financial markets, to provide accurate and timely predictions of aggregate hedging trades. This is critical for effective hedging as well as to offer the best (cost effective) price possible without inadvertently exposing Provider to undue risks at the aggregate level.

As shown in FIG. 3C, in an embodiment, the Book Manager 125 can comprise one or more modules configured to implement the foregoing operations of the Book Manager including, for example, a risk limit manager 370, a hedge strategy manager 375, a capital reserve manager 380 and a trade strategy manager 385.

As can be appreciated from the foregoing, the Adaptive Shield Server 10 is configured to nearly instantaneously identify, quote and then generate a synthesized financial product (i.e., the Shield protection) that is customized to a specific Customer Portfolio and that provides risk protection according to the Customer-defined protection parameters (e.g., protection period and amount).

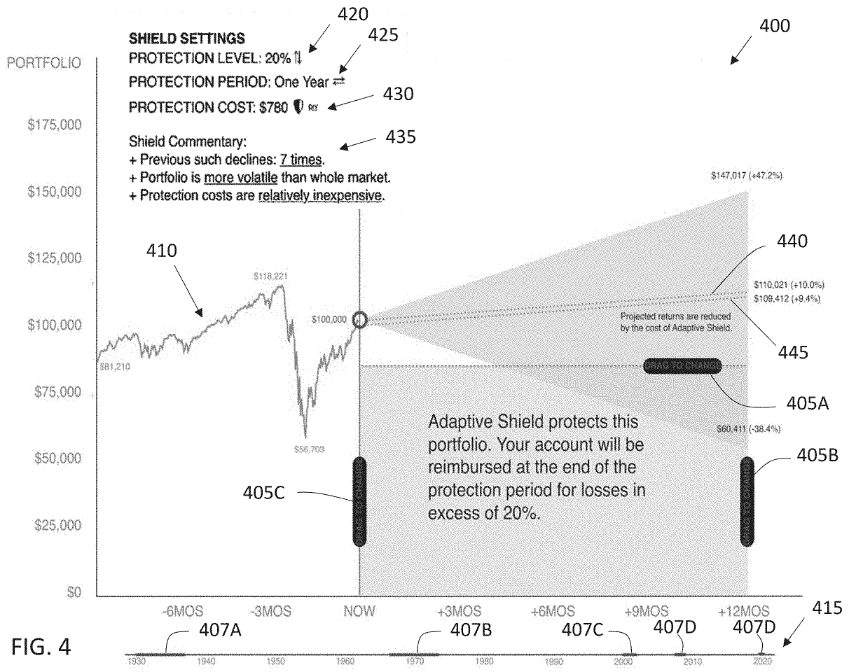

FIG. 4 is a screen shot of an exemplary interactive, graphical user interface 400 displayed via the Shield App to a Customer in connection with quoting an order for portfolio protection using the Shield. In some embodiments, once Customer has provided the Adaptive Shield Server 10 with access to a portfolio of holdings (manually or automatically) and the foregoing analysis has been performed on the Client Portfolio (historical and current), the Adaptive Shield Server 10 can be configured to generate a live, interactive responsive display that shows how many times, and when, in stock market history a certain kind of protection (e.g., a Customer input protection level and duration) would have limited losses for a given Client Portfolio (e.g. how many times and when has Customer's FAANG portfolio taken a 10% decline in the past). In particular, Adaptive System Server is configured to generate a real-time interactive, graphical user interface 400 that is custom to the Client Portfolio, showing:
a graphical chart 410 depicting the historical performance of Client Portfolio, including
   one or more adjustable zoom inputs that causes the display to zoom in/out of history; For instance, the zoom input can comprise one or more adjustable sliders (407A-407D) at the bottom of the graph. These sliders can be adjusted e.g. to show the market from year 2000 to 2010, and then show historically what the shield would have cost at the end of that selected period.
   and a timeline 415 of when protection would limit losses in past (e.g., 10-15 years).
a graphical projection of future performance of Client Portfolio, and displaying probabilities of gains or losses.
Adjustable Protection Level (e.g. protection against losses in excess of 20%), that includes an actuatable button 420 (e.g., increased/decrease) and triggers the Adaptive Shield Server to compute and output real-time adjustments in the associated Cost 430 and Commentary 435.
Adjustable Protection Period (e.g. protection through the end of the year), that includes an actuatable button 425 (e.g., increased/decrease) and triggers the Adaptive Shield Server to compute and output real-time adjustments in the associated Cost 430 and Commentary 435.
Additionally, parameters such as protection period and protection level can be adjusted using one or more interactive drag bars 405A-405C that are displayed on the interface and that, when manipulated by the user, cause the Adaptive Shield Server to dynamically compute and output real-time adjustments to the associated Cost 430, Commentary 435 and graphical renderings. For instance, the drag bar 405B can be adjusted horizontally (e.g., earlier or later) to change the end time protection period. For instance, the drag bar 405C can be adjusted horizontally (e.g., earlier or later) to change the start time of the protection period. The drag bar 405A can be moved up and down so as to change the protection level, say, from 100% to 95% to 90% etc.
Real-time Shield Cost quote and Commentary 430 can be generated by the Adaptive Shield Server 10 including:
   Shield Cost 430
   Natural language summary description of Client Portfolio risk level, with link to more verbose explanation.
   Natural language summary description of protections costs for Client Portfolio (e.g. “relatively inexpensive”), with link to more verbose explanation.
   Natural language summary description of how rare/common Protection would limit losses in the past (e.g. “Previous such declines: 7 times”), with link to more verbose explanation.
A projected line—Dotted line 440—showing the Portfolio's expected gains, showing Opportunity Cost of selling out and missing growth.
   Separate dotted line can also transparently displays the drag on performance due to cost of Shield.

This exemplary real-time interactive chart 400 uniquely and interactively can inform Customer about risk and volatility based on particular aspects of the Client Portfolio. Additional features that the Adaptive Shield Server 10 can be configured to provide via the user interface are noted next.

In some embodiments, the Adaptive Shield Server 10 can be configured to alert the Customer to aspects of the Portfolio that are causing the protection costs to be higher than they would otherwise be; in other words, how the Portfolio be changed to reduce the cost of Protection. This informs the Customer about risk.

In some embodiments, the Adaptive Shield Server 10 can be configured to inform Customers about Tail Risk. Particularly, Adaptive Shield Server can teach Customers that stock market risk is historically not symmetric and not normal—that is, even in a market with positive returns over the long-term, the risk of big declines is greater than the risk of big up moves. Crashes happen. In many senses, it is more “efficient” to hedge against Tail Risk than against Risk in general.

In some embodiments, the Adaptive Shield Server 10 can be configured to use natural language processing algorithms to provide Customer-specific Natural Language explanations for protection levels, e.g. “Give me Covid19 Crash Protection” or “Give me 9/11 Crash Protection” to match the Customer's own conceptualization of the Customer's fears, e.g. “I don't want to live through another Election Night Crash without protection.”

In some embodiments, the Adaptive Shield Server 10 can be configured to provide a Portfolio Risk Management Tool. More specifically, instead of providing the synthetic protection product constructed to hedge existing risk, the Adaptive Shield Server can be configured to provide added value by recommending changes to the portfolio and/or portfolio protection. In some embodiments, the Adaptive Shield Server can be configured to implement analytical algorithms to determine how to carve out protection to be more efficient and inform the Customer of the results, say, in a customized message “your TSLA shares are making this too expensive; don't buy protection.” In some embodiments, the Adaptive Shield Server can be configured to show multiple quotes for a Customer to select. For instance, as further described herein, as an alternative to the protection that matches the Customer Portfolio, the Adaptive Shield Server can offer a more “optimal” protection, which might not exactly match the portfolio, but is optimized based on one or more factors such as price.

In some embodiments, the Adaptive Shield Server can be configured to provide a Customer with a recommended Shield configuration that is tuned according to the current market environment. The recommended Shield configuration (e.g., 90% protection over the next 6 month period) can be generated using a machine learning algorithm. More specifically, the Adaptive Shield Server 10, including without limitation the customer data analysis server 112, can be configured to analyze the Customer's personal and financial profiles (e.g., past activity, historical of use of Shield, trading activity, demographics, and other such customer data) using suitable behavioral and economic analysis algorithms. The analysis can be performed to determine Customer behavioral characteristics, such as risk tolerance, that are useable to tailor the automatically generated recommendations to the particular Customer. The customer behavior can be inferred by analyzing the customer data in one or more dimensions including, analyzing the Customer, comparing the Customer to cohorts, and analyzing customer and cohorts together.

In some embodiments, the Adaptive Shield Server can be configured to adjust a tolerance of idiosyncratic exposure that expands as a function of the client base.

Exemplary features and functionalities provided by the Adaptive Shield Server via the GUI interfaces shown as FIGS. 2A-2B will be further appreciated with the following detailed discussion of the same with reference to the workflow 280 shown in FIG. 2C.

As noted, FIG. 2A is a screen shot of a GUI interface 210 showing a Customer's brokerage account page including a button 212 for activating a “Shield” tool provided by the one-click portfolio protection (OCPP) system 1 according to an embodiment. As should be understood, prior to arriving at the screen of FIG. 2A, the Customer would have input details concerning the Client Portfolio into the system.

For the purposes of this example, the Customer “Jane” may have a portfolio of assets that consists of the following two stocks: TSLA (Tesla) and AAPL (Apple). Upon logging in to her brokerage account, she can be presented with a common account summary page or a portfolio position page 210 as shown in FIG. 2A. She may navigate among the account pages. Any time she is on a page with account and or portfolio information, she will have access to the Adaptive Shield button 212. Here, the brokerage account page is serviced by her brokerage firm, a distribution partner, and the Shield button 212 can be embedded on this partner's website.

Elements of the GUI shown in FIG. 2A can include an Account Summary 214 and Text elements that show
Account Name, e.g., Adaptive Growth Fund, LLP
Account Balance, as of previous days closing price.
Today's G/L: showing intraday return of the hypothetical portfolio.
1-Year Return: showing the portfolio's historical 1-year return, assuming no changes in the previous year.

In some embodiments, the Shield-On Button 212 can comprise a slider that has two states: Off and On. In the “Off” mode, the circle can be on the left side of the slider bar, having optionally a particular color (e.g., orange or red to signify risk when off, and green if on). The text on the Button can additionally indicate “SHIELD OFF” which can be overlayed on top of the bar and the circle. In the “On” mode, the circle can be on the right side of the gray bar as shown. The text on the Button can say “SHIELD ON” which will be overlayed on top of the bar and the circle.

The GUI is configured to enable the customer to change the states by clicking on the left side of the bar (or swipe the button to the left) from the “ON” to the “OFF” position and click on the right side of the bar (or swipe the button to the right) to transition from the “OFF” to the “ON” position.

If a new Customer, the Customer will see the Button in the “OFF” state, and can slide the button to “ON” to attempt to activate the Shield. The system then can direct the Customer to an ensuing screen: the “Shield Setup Page” shown in FIG. 2B.

Continuing on in reference to FIG. 2A, the GUI 210 can represent the Shield State (Text). The text element will confirm the current state of the Shield based: i.e., “Shield is Currently On (/Off)”. Note, unlike the “Shield-On” button control, the state of the Shield preferably is configured to remain in “Off” until the Customer has completed setup, confirmed order, and accept order steps.

By way of further example, the GUI can include a Your Balance History field 216 which includes, for example, a chart that shows the balance of the account over time. This chart may be made dynamic, for example, allowing the Customer to select “1-day”, “1-month”, “ytd”, or “1-year”. These period selection options are not shown in FIG. 2A, however, they are as shown and described herein. The system can also be configured to present a benchmark comparison (not shown) in this chart, e.g., compare with S&P500 index for a US stock portfolio. This is not shown in FIG. 2A. In some embodiments, the chart can include a control input enabling a Customer to select a benchmark for comparison, or the Adaptive Shield Server 10 can automatically select a benchmark to present as default based on the risk exposure of the portfolio.

As shown, the Adaptive Shield Server 10 can be configured to present in the GUI a table of portfolio holdings 218 including, for example and without limitation: “Symbol”—stock ticker, specified by the Customer in the demo setup screen; “Quantity”—number of shares, specified by the Customer in the demo setup screen; “Last”—last price, showing the last closing prices, data drawn from the data server; “Tdy G/L”—gain and losses (price change from previous day closing*quantity), showing the current intraday g/l, data drawn from the data server; “% Chg”-expressing Tdy G/L in % term (price changes from previous day closing/previous day closing price). Note, certain fields can be updated upon reloading the web pages and therefore the GUI can be configured to draw from a live data table as well as from a historical data table.

In this exemplary embodiment, there is a single navigation button on the exemplary GUI screen of FIG. 2A, the “Shield-On” button 212. If the Shield was off, turning Shield on serves to bring the Customer to the second screen of FIG. 2B, the Shield Setup screen 220. This applies to both new Customers and Returning Customers. If the Shield was “On”, an attempt to turn Shield off will bring up a message box, asking the Customer to confirm. The system can also be configured to provide a warning message, to indicate the risk of turning Shield off at that moment. The system can also provide additional details of what the Customer can expect after they turn the Shield off, for example, new effective dates, and any rebates due.

FIG. 2B is a screen shot of a GUI interface showing an exemplary Shield tool parameter setup page 220 according to an embodiment. Continuing the practical example, after Jane clicks on the “SHIELD ON” control to activate Adaptive Shield, she can be directed to the Setup Page 220 for defining parameters of the Shield. FIG. 2B is a mock-up of the Setup Page.

Elements of the setup GUI shown in FIG. 2A include, a protection Period input. For instance, Radio Button(s) 224 are provided where choices of “Day”, “Month”, and “Year” can be selected. Changing a selection will serve to trigger the Adaptive System Server 10 to update the premium quote accordingly. Additionally, a protection level input 222 can be provided, for instance, a Range slider or other similar slider control can be provided within which the Customer can vary protection from, say, −20% to 0% in 1% increments.

In some embodiments, the system is configured to include an AI Text Box 226 below the Radio Buttons. Within the AI Text Box, the system can be configured to provide dynamic and customized messages based on the Customer profile, and Shield Setup. The message will be served up by the backend server 10 along with the quote. The message can be generated by the server 10, particularly the customer data analysis server 112, using various artificial intelligence and natural language algorithms applied to the data of the Customer profile and in view of the market data.

Also shown is a text Box 228 below the Slider that shows, in text, the protection level chosen. Also shown is a Quote field 230 within which the Quote based on the protection level and period selected is output. This quote is computed by the backend Adaptive System Server 10. In some embodiments, some calculation can be performed with inline code on this GUI page to reduce latency. For example, the quote can be presented as cost per day, month or year depending on the protection period selected.

In some embodiments, the system can be further configured to output via the GUI a text quote 232 of estimated and hypothetical cost of protection if individual Customer is to construct the hedging trades on their own. This cost will be computed by the backend server (but possibly have some of the calculation done with inline code on this page to reduce latency).

The exemplary GUI of FIG. 2B also includes “Confirm” and “Cancel” Buttons 234. Clicking on Confirm can cause the GUI to transition to a separate confirmation screen (or in addition or alternatively confirm the order to the back-end server). Clicking on Cancel causes the GUI to transition back to the account page (see FIG. 2A).

In some embodiments, the system can be further configured to present a DIY Trade Detail screen (not shown). This can be a pop-up window or a call-out window that displays when the Customer clicks on the DIY cost or hover over the DIY cost. This window can show the list of hedging securities to purchase and the associated cost of the hedge (by trade instrument, and total costs of the trade).

In some embodiments, the configuration page can include, a textbox with AI customized messages, e.g., describing backtest scenarios for Client Portfolio and/or Smart Advisor messages to help Customer make alternative decisions. By way of further example, the confirmation page can include graphics showing back-test cumulative returns of Client Portfolio with the effect of Shield. The back-test screen can allow the Customer to see how the Shield would have performed over history. The Customer can select a portfolio, specify a date range e.g. Jan. 4, 2020 to May 3, 2020, and a protection level e.g. 90%. The OCPP system can then process the portfolio and historical financial data for the date range in question in the manner shown and described above for forward looking Shield protection to evaluate how the portfolio would have fared had Shield been applied over the historical date range. The output of the backtest screen can also include a graphical comparison showing how the portfolio would have behaved with Shield versus without Shield. At a minimum, the confirm page might include a Text Box displaying standard contract terms with check box for “Agree to the Terms” iv. Accept or Decline command buttons. It should be appreciated that the back-test screen can similarly be generated and shown to the Customer in other user landing pages.

In some embodiments, if the Customer selects Decline, and the previous Shield-On/Off Button was in the Off Position, the System can be configured to record the Customer's recently input Settings in Customer Data Server for future Shield-on usage. If the Customer selects, Decline, and if the previous Shield-On Button was in the On Position, such new settings can be discarded and the Customer returned back to Setup Page.

In some embodiments, if the Customer selects Accept, if the Customer slides the Shield-On button from the Off to the On position, the order is completed and the Customer is returned to the account page showing the updated status. If the Customer selects Accept and if the Customer slides the Shield-On button from the On to the Off position, the GUI can be configured to Display Dialog Box with Shield-On Button in the On Position.

In some embodiments, if the Customer already has the Shield tool setup with previously defined parameters, the system can be configured to enter a truncated confirmation and implementation routine. For instance, if the Shield-On Button visible on Customer's Account Page is either in On or Off positions, if Customer slides from the Off to On position the system can directly present the Confirm Page/state. If the Customer slides from On to Off position, the system can be configured to present a Dialog box requesting for confirmation, and indicate if there is any penalty (e.g., processing cost). If the Customer confirms, the off order is processed and the Customer is returned back to the account page with Shield set to “Off”. If the Customer cancels, the Customer is returned back to account with Shield set to “On”.

In some embodiments, if an existing Shield setup exists for the Customer, the Customer can be provided with an edit Shield Settings Button visible on the account page. If the Customer clicks Edit Shield Settings Button, the system can display a dialog for confirmation (e.g., “Are you sure you want to change Shield settings? Note, changing Shield settings while Shield on may incur additional costs”). If the Customer confirms, then the Customer can be transitioned to the Setup Page. If the Customer cancels, the Customer can be returned to the Account Page with no change to the state of Shield-On Button.

In some embodiments, the portfolio protection product offered using the OCPP system 1 can be guaranteed. In some embodiments, the portfolio protection product offered using the OCPP system 1 can be approximate (not-guaranteed). More specifically, preferably, the OCPP system 1 is configured to analyze a customer's portfolio, analyze its contents, and provide a price for the protection product which is guaranteed. This can be challenging to do in a guaranteed way for every possible portfolio. The capacity to offer guarantees can depend on the overall size of the Customer portfolios protected, and the behavior of their specific contents (e.g., are the shares volatile, or not). Accordingly, in some embodiments, the OCPP system 1 can be configured to offer a protection product with unlimited capacity, but which does not offer a guarantee that is specifically tied to the Customer Portfolio. In particular, the OCPP system can be configured to identify a portfolio which is a suitable analog to the Customer Portfolio (e.g., within a prescribed degree of similarity) and which the OCPP system can generate a protection product for with unlimited capacity. Accordingly, while the protection product can guarantee on the slightly different portfolio that was assessed to be “reasonably close” to the Customer Portfolio, the protection for the Customer Portfolio is not guaranteed due to possible tracking error between the Customer Portfolio and the analogous portfolio.

Furthermore, in some embodiments, the OCPP system can be configured to present a Customer with a “Self Assembly Protection” screen (e.g., the DIY Trade Detail screen previously mentioned) and provide a corresponding tool that the investor can use to set up downside protection for themselves and/or evaluate alternative Shield protection products that each have respective prices and guarantees. In particular, the Adaptive Shield Server 10 can be configured to provide to the Customer within this tool interface, a list of protection product options including a first option to purchase protection one for one with the portfolio holdings, which provides guaranteed protection at the level selected. The Customer can also be provided with a list of Shield options to purchase which can be less expensive than the first option and are correlated by the server 10 to the Customer portfolio being protected to varying degrees of similarity, but which are not guaranteed as they might allow the Customer portfolio to fall below the protection level selected.

As can be appreciated from the foregoing discussion, exemplary systems for near-instantaneous portfolio protection in accordance with the disclosure can comprise one or more of the following points: An Adaptive Shield Server 10 residing within a private cloud and including one or more database servers or application servers including:

a Client and Client Broker API 110 configured to interface with one or more of a Client Broker Server and Client Interface wherein the Client and Client Broker API is configured to retrieve Client Portfolio data from the Client Broker Server, and wherein the Client and Client Broker API is configured to receive via the Customer user interface a Customer's actuation of a Shield Button to initiate the portfolio protection and settings concerning the portfolio protection;

a Market Data Server 115 configured to receives price and order data from one or more of Third Party Data Servers, coordinate short and long-term storage of such information, and calculates market data points, wherein the Market Data Server is configured to generate models for predicting various data points that are provided to a Risk Pricer Server 120 including risk factors and pricing information;

the Risk Pricer Server, wherein the Risk Pricer Server, based on the actuation of the Shield button, settings and portfolio data, is configured to compute a risk level and price associated with the client portfolio protection and wherein the Risk Pricer Server is also configured to calculate an aggregate risk of multiple clients including the client and construct suitable hedges accordingly;

a Book Manager 125 configured to interface with the Market Data Server and Risk Pricer, wherein the Book Manager is configured to identify and assess specific trades required to manage the aggregate risk and automatically purchase protection accordingly via an electronic Trader and the Trader 130, wherein the Trader is configured to interface with one or more 3rd Party Broker servers and automatically place orders and execute trades in accordance with protection purchase instructions received from the Book Manager Server 125.

Although the OCPP system is shown and described above as a platform configured to provide near-instantaneous portfolio protection, the features and functionality of the platform can be similarly utilized to provide an “Income” product to Customers, in addition, or alternatively, to protection. More specifically, whereas the Shield product generated by the OCPP system 1 is, in essence, a synthetic “put” on the underlying securities of a Customer Portfolio, the OCPP system 1 can similarly generate an income product in the form of synthetic “call” options on the underlying securities of one or more Customer Portfolios.

A “platform,” as used in this disclosure, means any computer hardware, software, or combination of hardware and software, including, for example, computer hardware and operating system software.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, a server farm, a computer cloud, or the like, or an array of processors, microprocessors, central processing units, general purpose computers, super computers, personal computers, laptop computers, palmtop computers, notebook computers, desktop computers, workstation computers, servers, server farms, computer clouds, or the like.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication(s) link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G, 4G or 5G cellular standards, Bluetooth, or the like. A communication(s) link may include a public switched telephone network (PSTN) line, a voice-over-Internet-Protocol (VoIP) line, a cellular network link, an Internet protocol link, or the like. The Internet protocol may include an application layer (e.g., BGP, DHCP, DNS, FTP, HTTP, IMAP, LDAP, MGCP, NNTP, NTP, POP, ONC/RPC, RTP, RTSP, RIP, SIP, SMTP, SNMP, SSH, Telnet, TLS/SSL, XMPP, or the like), a transport layer (e.g., TCP, UDP, DCCP, SCTP, RSVP, or the like), an Internet layer (e.g., IPv4, IPv6, ICMP, ICMPv6, ECN, IGMP, IPsec, or the like), and a link layer (e.g., ARP, NDP, OSPF, Tunnels (L2TP), PPP, MAC (Ethernet, DSL, ISDN, FDDI, or the like), or the like. “Network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., thousands of) memory caches on multiple (e.g., thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G, 4G, or 5G cellular standards, Bluetooth, or the like.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system for near-instantaneous portfolio protection, the system comprising:
an Adaptive Shield Server residing within a private cloud, the adaptive Shield Server including:
a Client and Client Broker ΔPI configured to interface with a Client Broker Server and a Client user Interface, wherein the Client and Client Broker ΔPI is configured to retrieve Client Portfolio data from the Client Broker Server for a Customer, and wherein the Client and Client Broker ΔPI is configured to receive, via the Client Interface, the Customer's actuation of a Shield Button to initiate creation of a portfolio protection product for the Client Portfolio and settings concerning the portfolio protection, wherein the settings include a temporal term that the portfolio protection is active and an amount of coverage, wherein the portfolio protection covers any decline in the Client Portfolio within the amount;
a Market Data Server configured to receive market data including price and order data from one or more Third Party Data Servers, coordinate short and long-term storage of such information, and selectively compile market data points;
a Risk Pricer Server configured to compute, based on the settings, Client Portfolio data and the market data points, a risk level and a price associated with the portfolio protection, and calculate an aggregate risk of multiple Customers including the Customer, wherein the Risk Pricer Server is further configured to construct a plurality of hedges to provide the portfolio protection and as a function of the aggregate risk;
a Book Manager configured to interface with the Market Data Server and Risk Pricer, wherein the Book Manager is configured to assess and identify specific trades required to provide the portfolio protection as a function of the aggregate risk, and wherein the Book Manager is configured to automatically generate protection purchase instructions for executing the specific trades via an electronic Trader; and
the Trader, wherein the Trader is configured to interface with one or more 3rd Party Broker servers and automatically place orders to execute the specific trades in accordance with the protection purchase instructions received from the Book Manager Server.

2. The system of claim 1, wherein the Market Data Server further comprises a Data Stager module, wherein the Data Stager module is configured to throttle arrival of asynchronous intra-day real-time price and order data and construct synchronized full time-bars of market data points, wherein the full time-bars have respective time intervals.

3. The system of claim 2, wherein the Data Stager module is configured to stage incomplete time-bars of market data points, and wherein the Risk Pricer is configured to interpolate market data points missing from the incomplete time-bars as a function of previously constructed full-time bars of market data using one or more interpolation algorithms.

4. The system of claim 3, wherein the Risk Pricer is configured to implement a deep-learning algorithm trained on historical data representing a relationship between previous time-bars at varying intervals and a current time-bar to predict prices of a newest incomplete time-bar, and wherein the Risk Pricer is further configured to dynamically adjust the value of the predicted prices in near-real time as additional price and order data is received relating to the newest incomplete time-bar.

5. The system of claim 1, further comprising: an Operational Data Store in operative communication with the Market Data Server, wherein the Operation Data Store is configured to store current and recent time-bars of market data points generated by the Market Data Server.

6. The system of claim 5, wherein the Market Data Server stores the received price and order data and market data points in the Operational Data Store according to a database schema that separates historical data from real-time data in respective data stores, and that separates storage of simple-structured data, complex-structured data and un-structured data in respective data stores.

7. The system of claim 6, wherein the Data Stager can be configured to selectively apply data analysis and cleaning algorithms as a function of a type of data or a respective data store.

8. The system of claim 7, wherein the Data Stager is configured to apply a data cleaning algorithm to reconcile real-time data at a time of use for such data thereby reducing a computational load on the Adaptive Shield Server.

9. The system of claim 1, wherein the Client and Client Broker ΔPI is configured to output the calculated price associated with the portfolio protection to the Customer via the Client Interface and receive, via the Client Interface, a confirmation representing the Customer's confirmed order for the portfolio protection.

10. The system of claim 1, wherein the Risk Pricer is configured to calculate the price as a function of a time delay between a first time at which the Shield Button is actuated to initiate creation of the portfolio protection product and a second time at which the specific trades will be executed, and wherein the Risk Pricer is configured to predict the second time and determine a risk associated with the time delay.

11. A method for near-instantaneous portfolio protection, the method comprising:
retrieving, by a Client and Client Broker ΔPI Server of a processing system residing within a private cloud, Client Portfolio data concerning a portfolio of financial assets owned by a Customer, wherein the Client Portfolio data is retrieved from a Client Broker Server;
receiving, by the Client and Client Broker ΔPI server from the Client via a user interface presented to a Customer at a remote computing device, an actuation of a Shield Button by the Customer to initiate creation of a portfolio protection product for the Client Portfolio, and receiving settings concerning the portfolio protection, wherein the settings include a temporal term that the portfolio protection is active and an amount of coverage, wherein the portfolio protection covers any decline in the Client Portfolio within the amount;
receiving, by a Market Data Server of the processing system from one or more Third Party Data Servers, market data including price and order data, wherein the market data comprises real-time and historical data;
selectively compiling, by the Market Data Server from the received market data, salient market data points and coordinating short and long-term storage of received market data and the compiled market data points;
computing, by a Risk Pricer Server of the processing system, based on the settings, Client Portfolio data and the market data points, a risk level and a price associated with the portfolio protection;
calculating, by the Risk Pricer Server, an aggregate risk of multiple Customers including the Customer,
constructing, by the Risk Pricer Server, a plurality of hedges to provide the portfolio protection as a function of the calculated aggregate risk;
identifying, by a Book Manager Server of the processing system, specific trades required to provide the portfolio protection as a function of the aggregate risk, wherein the Book Manager is configured to interface with the Market Data Server and Risk Pricer;
automatically generating, by the Book Manager based on the identified specific trades, protection purchase instructions for executing the specific trades via an electronic Trader; and
automatically placing, by the Trader using one or more 3rd Party Broker servers in electronic communication therewith, trading orders to execute the specific trades in accordance with the protection purchase instructions generated by the Book Manager Server.

12. The method of claim 11, wherein the market data points are compiled into time bars, and wherein the Market Data Server comprises a Data Stager module, and wherein the step of selectively compiling the market data points from the received market data comprises,
throttling, by the Data Stager module, arrival of asynchronous intra-day real-time price and order data; and
constructing synchronized full time-bars of market data points, wherein the full time-bars have respective time intervals.

13. The method of claim 12, wherein the step of selectively compiling the market data points from the received market data further comprises:
staging, by the Data Stager module, incomplete time-bars of market data points; and
interpolating, by the Risk Pricer, market data points missing from the incomplete time-bars as a function of previously constructed full-time bars of market data using one or more interpolation algorithms.

14. The method of claim 13, further comprising:
implementing, by the Risk Pricer, a deep-learning algorithm trained on historical data representing a relationship between previous time-bars at varying intervals and a current time-bar to predict prices of a newest incomplete time-bar; and
dynamically adjusting, by the Risk Pricer, values of the predicted prices in near-real time as additional price and order data is received relating to the newest incomplete time-bar.

15. The method of claim 14, wherein an Operational Data Store in operative communication with the Market Data Server and wherein current and recent time-bars of market data points generated by the Market Data Server are stored in the Operational Data Store.

16. The method of claim 15, further comprising:
storing, by the Market Data Server in the Operational Data Store, the received price and order data and the market data points according to a database schema that separates historical data from real-time data in respective data stores, and that separates storage of simple-structured data, complex-structured data and un-structured data in respective data stores.

17. The method of claim 16, further comprising:
selectively applying, by the Data Stager, data analysis and cleaning algorithms to at least a portion of the received price and order data as a function of one or more of a respective type of the at least the portion of the received price and order data and which of the respective data stores the at least the portion of the received price and order data is stored to.

18. The method of claim 17, wherein the Data Stager applies a data cleaning algorithm to reconcile real-time data at a time of use for such data and thereby reducing a computational load on the Adaptive Shield Server.

19. The method of claim 11, further comprising:
outputting, by the Client and Client Broker ΔPI server to the Customer via the Client Interface, the calculated price associated with the portfolio protection; and
receiving, by the Client and Client Broker ΔPI server via the Client Interface, a confirmation representing the Client's confirmed order for the portfolio protection, and wherein the step of automatically placing the trading orders is performed in response to the confirmation.

20. The method of claim 11, wherein the actuation of the Shield Button initiating creation of the portfolio protection product is received at a first time, and the method further comprising:
predicting, by the Risk Pricer, a second time at which the specific trades will be executed; and
calculating, by the Risk Pricer, a risk associated with a time delay between the first time and the predicted second time, and wherein the Risk Pricer calculates the price of the protection as a function of the risk associated with the time delay.
